(19) United States
(12) Patent Application Publication
(10) Pub. No.: US 2024/0264180 A1
(43) Pub. Date: Aug. 8, 2024

(54) INSTRUMENT FOR AUTOMATICALLY DISSECTING A BIOLOGICAL SPECIMEN ON A SLIDE

(71) Applicant: Roche Molecular Systems, Inc., Pleasanton, CA (US)

(72) Inventor: Joachim Wietzorrek, Zug (CH)

(21) Appl. No.: 18/639,834

(22) Filed: Apr. 18, 2024

Related U.S. Application Data
(63) Continuation of application No. PCT/EP2022/081087, filed on Nov. 8, 2022.

(30) Foreign Application Priority Data
Nov. 9, 2021 (EP) 21207163.3

(51) Int. Cl. G01N 35/00

(52) U.S. Cl. CPC G01N 35/00029

(57) ABSTRACT

An instrument for automatically dissecting a biological specimen on a slide. The instrument comprises at least one imaging system. The imaging system comprises at least one camera configured for sequentially imaging at least one image of the slide at a plurality of slide positions. The imaging system comprises a relay lens system having a fixed focal length. The relay lens system is configured for relaying an impinging light beam from the slide to the camera. The instrument further comprises a movable xy-stage configured for setting the slide position. The instrument further comprises at least one processing unit configured for generating a full slide image by stitching the sequentially imaged images of the slide. Further, a method for automatically dissecting a biological specimen on a slide is proposed.

### CROSS-REFERENCE TO RELATED APPLICATIONS

This application is a continuation of International Patent Application No. PCT/EP2022/081087, filed 8 Nov. 2022, which claims priority to European Patent Application No. 21207163.3, filed 9 Nov. 2021, the disclosures of which are hereby incorporated by reference in their entirety.

### TECHNICAL FIELD

The present disclosure relates to an instrument for automatically dissecting a biological specimen on a slide, a method for automatically dissecting a biological specimen on a slide, a computer program and computer-readable storage medium. Herein, the devices and methods can be used in the field of tissue diagnostics such as for digital pathology, in particular for dissection of formalin-fixed paraffin-embedded (FFPE) tissue areas of interest. However, further uses are feasible.

### BACKGROUND

Biological specimens such as tissue sections, blood, cell cultures, and like biological samples, are mounted on a slide, stained with one or more combinations of stain and biomarkers, and the resulting assay is imaged for further analysis of the content of the specimens using a digital pathology system. Moreover, either stained or unstained paraffin embedded tissue sections may be dissected for further molecular or genomic analysis. For example, in “A mill based instrument and software system for dissecting slide-mounted tissue that provides digital guidance and documentation”, https ://bmcclinp athol.biomedcentral. com/article s/10.1186/1472-6890-13-29, BMC Clinical Pathology volume 13, Article number:29 (2013) meso-dissection of specific Areas Of Interest (AOIs) of slide mounted tumor samples is described.

Automated tissue dissection systems, such as the AVENIO® Millisect System, are known to enable precise and consistent recovery of formalin-fixed paraffin-embedded (FFPE) tissue areas of interest for molecular pathology. The system can be decomposed into a milling machine for mechanical dissection and an imaging system for controlling the milling machine. Different sizes of field of view and different levels of optical resolution are required for navigation through a microscope slide holding the tissue. It is known to use a zoom lens system having a variable focal length. However, zoom lenses are costly and show low optical performance. Three actuators are essential for control of focus, zoom and iris in order to support both, a large field of view and a high pixel density in the specimen plane. However, these two features are not supported in one go. Multiple acquisitions of frames are necessary.

### SUMMARY

Although the embodiments of the present disclosure are not limited to specific advantages or functionality, it is noted that in accordance with the present disclosure an instrument for automatically dissecting a biological specimen on a slide, a method for automatically dissecting a biological specimen on a slide, a computer program and computer-readable storage medium are described, which at least partially avoid the shortcomings of known devices and methods of this kind and which at least partially address the above-mentioned challenges. Specifically, excellent optical performance of an imaging system of the instrument along with a very low price shall be reached.

In accordance with one embodiment of the present disclosure, an instrument for automatically dissecting a biological specimen on a slide is provided, wherein the instrument comprises at least one imaging system, wherein the imaging system comprises at least one camera configured for sequentially imaging at least one image of the slide at a plurality of slide positions, wherein the imaging system comprises a relay lens system having a fixed focal length, wherein the relay lens system is configured for relaying an impinging light beam from the slide to the camera, wherein the instrument comprises a movable xy-stage configured for setting the slide position, wherein the instrument comprises at least one processing unit configured for generating a full slide image by stitching the sequentially imaged images of the slide, and wherein the relay lens system comprises a plurality of lenses, wherein the lenses are arranged symmetrically or quasi-symmetrically with respect to at least one plane of symmetry perpendicular to an optical axis.

In accordance with another embodiment of the present disclosure, a method for automatically dissecting a biological specimen on a slide using an instrument for automatically dissecting a biological specimen on a slide according to an embodiment of the disclosure is provided, wherein the method comprises the following steps: setting a plurality of slide positions using the movable xy-stage; at each slide position, relaying an impinging light beam from the slide to the camera by using the relay lens system having a fixed focal length and sequentially imaging at least one image of the slide at a plurality of slide positions by using the at least one camera of the at least one imaging system; and stitching the sequentially imaged images of the slide thereby generating a full slide image by using the processing unit.

These and other features and advantages of the embodiments of the present disclosure will be more fully understood from the following detailed description taken together with the accompanying claims. It is noted that the scope of the claims is defined by the recitations therein and not by specific discussions of features and advantages set forth in the present description.

### BRIEF DESCRIPTION OF THE DRAWINGS

The following detailed description of the embodiments of the present disclosure can be best understood when read in conjunction with the following drawings, where like structure is indicated with like reference numerals and in which:

FIG. 1 shows a schematic illustration of an instrument for automatically dissecting a biological specimen on a slide according to an embodiment of the present disclosure;

FIG. 2 shows a schematic illustration of the relay lens system;

FIG. 3 shows a top view of an exemplary slide;

FIGS. 4A to 4B show spot diagrams;

FIG. 5 shows a contrast transfer function;

FIG. 6 shows a root mean square error;

FIG. 7A shows a field curvature;

FIG. 7B shows a field distortion; and

FIG. 8 shows a vignetting and spatial uniformity.

Skilled artisans appreciate that elements in the figures are illustrated for simplicity and clarity and have not been drawn to scale. For example, dimensions of some of the elements in the figures may be exaggerated relative to other elements to help improve understanding of the embodiment(s) of the present disclosure.

### DETAILED DESCRIPTION

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e., a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “typically”, “more typically”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The disclosure may, as the skilled person will recognize, be performed by using alternative features Similarly, features introduced by “in an embodiment of the disclosure” or similar expressions are intended to be optional features, without any restriction regarding alternative embodiments of the disclosure, without any restrictions regarding the scope of the disclosure and without any restriction regarding the possibility of combining the features introduced in such way with other optional or non-optional features of the disclosure.

The term “biological specimen” as used herein is a broad term and is to be given its ordinary and customary meaning to a person of ordinary skill in the art and is not to be limited to a special or customized meaning. The term specifically may refer, without limitation, to an arbitrary type of biological sample that can be mounted on a slide. The biological specimen may be any type of biological material, and can be derived from a variety of biological organisms, including animals, humans, plants, fungus, and the like. The biological specimen itself may be any material derived from a biological organism, including tissue, tissue sections, organs, organ sections, cells, cultured cells, cultured tissue, plant matter, secretions, excretions, and the like, including combinations thereof. The biological specimen may be embedded in a matrix such as plastic, paraffin, a gel, or any other material or agent. The biological specimen may be in a solid, or semisolid form. For example, the biological specimen may be a fresh or frozen biological sample or sample sections.

The term “slide” as used herein is a broad term and is to be given its ordinary and customary meaning to a person of ordinary skill in the art and is not to be limited to a special or customized meaning. The term may, specifically, refer, without limitation, to a substrate which is designated for a biological specimen, e.g., a sample, to be mounted on a surface of the slide. In particular, for a purpose of carrying the biological specimen without any changes during the processing to the slide, the substrate is mechanically stable and can, therefore comprise any material which provides sufficient mechanical stability. In particular, for a purpose of carrying a biological specimen, the substrate may typically exhibit a surface which is configured to be compatible with biological material. By way of example, the slide is a glass slide since glass is known, on one hand, to provide sufficient mechanical stability and, on the other hand, to have a high compatibility with biological material. However, further kinds of materials for the slides may also be feasible. For a purpose of generating the desired image of the specimen, the slide may, typically, be a plate having a 2D extension and a thickness, wherein the 2D extension of the plate may, typically, exhibit a rectangular or circular form, and wherein the thickness of the plate may be small compared to a size of the extension, typically 20%, more typically 10%, in particular 5%, or less than a measure for a linear extent of the 2D extension of the plate. Further, the slide may, in particular, have a form which may enable imaging of the biological specimen mounted on the slide. The slide may be a milling slide, i.e., the slide intended to be dissected by the instrument. For example, the slide may be a biological specimen slide or tissue slide. For example, the slide may be an unstained biological specimen or tissue slide. For example, the slide may be a formalin-fixed, paraffin-embedded (FFPE) slide.

The term “dissecting” as used herein is a broad term and is to be given its ordinary and customary meaning to a person of ordinary skill in the art and is not to be limited to a special or customized meaning. The term may specifically refer, without limitation, to a process of extracting at least one specific area of interest of the biological specimen mounted on the slide. The extracting may comprise one or more of cutting, disrupting, milling and the like. Several techniques for dissecting are known by the skilled person. For example, the dissecting may comprise ablating such as by scraping the biological specimen, e.g., by using at least one cutting device such as a scalpel, also denoted as macrodis section, and/or by using laser-based instruments, also denoted as Laser Capture Microdissection (LCM). For example, the dissecting may comprise mesodissection. The mesodissection may be performed as described in US 2014/0329269, WO 2016/120433 A1, or U.S. Pat. No. 10,876,933 B2, which are incorporated herein in entirety by reference. The instrument may comprise at least one milling machine. The milling machine may comprise at least one extractor, such as a cutting tip, configured for extracting the at least one specific area of interest of the biological specimen mounted of the slide. The milling machine may comprise further elements such as at least one liquid dispensing port configured for dispensing liquid to the slide and/or at least one liquid aspiration port configured for aspirating liquid to the slide at a sample facing side of the extraction device. The milling machine may be designed as in the AVENIO® Millisect system.

The term “automatically” as used herein is a broad term and is to be given its ordinary and customary meaning to a person of ordinary skill in the art and is not to be limited to a special or customized meaning. The term may, specifically, refer, without limitation, to a process which is performed completely by means of at least one computer and/or computer network and/or machine, in particular without manual action and/or interaction with a user. The instrument may further comprise at least one xy-stage configured for relative positioning of the slide and the extractor. The xy-stage may be a motorized xy-stage. The xy-stage may be coupled to the slide and may move the slide in an xy-plane. Movement of the xy-stage and/or of the extractor may be controlled by at least one control unit. For example, for automatically dissecting of the biological specimen, the instrument may comprise the control unit configured for controlling the xy-stage and the extractor. The instrument further may comprise a processing unit functionally coupled to the control unit. The processing unit may be configured for identifying the specific area of interest of the biological specimen to be extracted, wherein the control unit may be configured for moving the xy-stage and/or the extractor to extract the biological specimen based on the findings of the processing unit. The term “automatically” may comprise completely automatic dissecting, e.g., comprising automatically loading of the slide, automatic identifying of the area of interest and automatic extraction. However, manual steps may be possible such as for loading the slide, correction of position and the like.

The instrument comprises at least one imaging system. The imaging system comprises at least one camera configured for sequentially imaging at least one image of the slide at a plurality of slide positions. The imaging system comprises a relay lens system having a fixed focal length. The relay lens system is configured for relaying an impinging light beam from the slide to the camera. The instrument comprises the movable xy-stage configured for setting the slide position. The instrument comprises the at least one processing unit configured for generating a full slide image by stitching the sequentially imaged images of the slide.

The term “system” as used herein is a broad term and is to be given its ordinary and customary meaning to a person of ordinary skill in the art and is not to be limited to a special or customized meaning. The term specifically may refer, without limitation, to an arbitrary set of interacting or interdependent components parts forming a whole. Specifically, the components may interact with each other in order to fulfill at least one common function. The at least two components may be handled independently or may be coupled or connect-able.

The term “imaging system” as used herein is a broad term and is to be given its ordinary and customary meaning to a person of ordinary skill in the art and is not to be limited to a special or customized meaning. The term specifically may refer, without limitation, to a sy stem configured for performing at least one imaging function. The term “imaging” as used herein is a broad term and is to be given its ordinary and customary meaning to a person of ordinary skill in the art and is not to be limited to a special or customized meaning. The term may, specifically, refer, without limitation, to generating and/or providing a 2D two-dimensional representation of at least one property of the biological specimen, also denoted by the term “image”. The image can typically, be processed and displayed on a screen for being regarded by eyes of a viewer, typically, without any further aids, apart from eyeglasses of the viewer. The imaging may comprise generating and/or providing a digital image. The term “digital image” as used herein is a broad term and is to be given its ordinary and customary meaning to a person of ordinary skill in the art and is not to be limited to a special or customized meaning. The term specifically may refer, without limitation, to a discrete and discontinuous representation of the image. Thus, the term “digital image” may refer to a two-dimensional function, f(x,y), wherein intensity and/or color values are given for any x, y-position in the digital image, wherein the position may be discretized corresponding to recording pixels of the digital image.

The term “camera” as used herein is a broad term and is to be given its ordinary and customary meaning to a person of ordinary skill in the art and is not to be limited to a special or customized meaning. The term specifically may refer, without limitation, to at least one imaging device having at least one imaging element configured for recording or capturing spatially resolved one-dimensional, two-dimensional or even three-dimensional optical data or information. The camera may be a pixelated camera. For example, the camera may be a charge-coupled device (CCD) and/or a complimentary metal-oxide semiconductor (CMOS) image sensor. The camera may comprise at least one camera chip, such as at least one CCD chip and/or at least one CMOS chip. However, further kinds of imaging devices may also be feasible.

The term “sequentially imaging” as used herein is a broad term and is to be given its ordinary and customary meaning to a person of ordinary skill in the art and is not to be limited to a special or customized meaning. The term may, specifically, refer, without limitation, to imaging the slide at a plurality of different x,y-position positions. The x,y-position may be set using the xy-stage, e.g., a motorized xy-stage, configured for relative movement of the slide and the camera. The sequentially imaging may comprise scanning the slide.

The term “relay lens system” as used herein is a broad term and is to be given its ordinary and customary meaning to a person of ordinary skill in the art and is not to be limited to a special or customized meaning. The term may, specifically, refer, without limitation, to a system configured for relaying an impinging light beam from the slide to the camera. The relay lens system may be configured for extending a length of the optical system of the instrument. The relay lens system may be configured for inverting the image.

The relay lens system has a fixed focal length. As used herein, the term “focus”, is a broad term and is to be given its ordinary and customary meaning to a person of ordinary skill in the art and is not to be limited to a special or customized meaning. The term specifically may refer, without limitation, to a distance over which incident collimated rays which may impinge on the relay lens system are brought into a point on an optical axis of the relay lens system. The term “focus” and “focal length” are used as synonyms herein. Thus, the focus constitutes a measure of an ability of the relay lens system to converge an impinging light beam. The relay lens system may comprises a plurality of lenses. The focus may refer to the effective focal length of the relay lens system. As used herein, the term “fixed focal length”, is a broad term and is to be given its ordinary and customary meaning to a person of ordinary skill in the art and is not to be limited to a special or customized meaning. The term specifically may refer, without limitation, to the fact that the focal length of the relay lens system is fixed, in particular non-adjustable. The focal length of the relay lens system may be defined by the selection and fixed position of the respective lenses comprised by the relay lens system. Thus, in comparison to known instruments for dissecting using a zoom lens, the present disclosure proposes replacing the zoom lens with a lens system having a fixed focal length. In comparison to zoom lenses such fixed focal length lenses have a very low price.

EP 3 401 721 A1 proposes a concept in which the focus is adjusted and using flash light for illumination which is essential as the focus is changed continuously. In contrast to the concept of EP 3 401 721 A1, the present disclosure proposes a lens system with a fixed focal length. For the present disclosure, using flash light is not required but continuous illumination is possible.

As outlined above, the relay lens system may comprise a plurality of lenses. The lenses may be arranged symmetrically or quasi-symmetrically with respect at least one plane of symmetry perpendicular to an optical axis. The relay lens system may constitute the optical axis. The plane perpendicular to the optical axis may be the x,y-plane. The relay lens system may constitute a coordinate system, wherein “z” is a coordinate along the optical axis, also denoted as z-axis or z-direction. A coordinate along the z-axis may be considered a longitudinal coordinate z. The directions transversal to the z-axis may be considered as x- and y-directions. The x- and y-directions span the x,y-plane. As used herein, the term “symmetrically”, is a broad term and is to be given its ordinary and customary meaning to a person of ordinary skill in the art and is not to be limited to a special or customized meaning. The term specifically may refer, without limitation, to a completely and/or strictly symmetric arrangement of the lenses with respect to the plane of symmetry perpendicular to the optical axis. The symmetric arrangement may refer to the number of lenses arranged with respect to the plane of symmetry and/or lens types and/or properties with respect to the plane of symmetry. The relay lens system may comprise a plurality of lenses, wherein one half of the plurality of lenses is arranged on one side with respect to the plane of symmetry and the other half of the plurality of lenses is arranged on another side with respect to the plane of symmetry. For example, the relay lens system may comprise 10 lenses, wherein 5 lenses are arranged on the one side with respect to the plane of symmetry and the other 5 are arranged on the other side with respect to the plane of symmetry. The relay lens system may comprise a plurality of lenses, wherein the type and/or properties of the lenses on the one side with respect to the plane of symmetry is mirrored on the other side with respect to the plane of symmetry. The plane of symmetry may be regarded as minor axis in a 2D section. An aperture stop is located in the plane of symmetry. As used herein, the term “quasi-symmetrically”, is a broad term and is to be given its ordinary and customary meaning to a person of ordinary skill in the art and is not to be limited to a special or customized meaning. The term specifically may refer, without limitation, to at least one deviation from a completely and/or strictly symmetric arrangement, e.g., in view of the number or types and/or properties of lenses used with respect to the plane of symmetry. For example, the relay system may comprise at least one additional element on one side with respect to the plane of symmetry. Thus, the relay lens system can be implemented with a strictly symmetric or quasi-symmetric designs allowing excellent optical performance along with a very low price.

For example, the relay lens system comprises ten lenses, wherein in direction of propagation of the light beam from the slide to the camera the relay lens comprises a bi-concave lens, a meniscus lens, a bi-convex lens followed by a cemented doublet lens comprising two elements, followed by a mirrored symmetric arrangement of said lenses.

As outlined above, the lenses may be arranged symmetrically with respect at least one plane of symmetry perpendicular to the optical axis. A strictly symmetric optical system is inherently free of the aberrations coma, lateral color and distortion. Therefore, beyond the constraint of symmetry or quasi-symmetry, the lenses may be designed in order to minimize remaining relevant aberrations like astigmatism, field curvature, spherical aberration and axial color. The lenses may be arranged with a strict symmetry. Strict symmetry implies that (i) the aperture stop of the lens is located directly at the symmetry plane, (ii) each lens in front of the aperture stop has a mirror symmetric counterpart behind the aperture stop and (iii) finally that the object has the same distance to the lens like the detector. This special case inevitably leads to a 1:1 image scale.

The imaging system may have an image scale of about 1:1. The relay lens system may have a unit magnification. As used herein, the term “image scale”, is a broad term and is to be given its ordinary and customary meaning to a person of ordinary skill in the art and is not to be limited to a special or customized meaning. The term specifically may refer, without limitation, to magnification, in particular a ratio between image and object size. A pixel size of the pixels of the camera may be selected to allow an image scale of 1:1. Even though the symmetry principle is a powerful concept in optics design, a strict implementation is not required in any case. Also quasi-symmetric optical designs and image scales beyond 1:1 in the range from 0.8:1 to 1.2:1 may manifest a typical solution in terms of low cost and high optical performance.

For example, the relay lens system may comprise a Numerical Aperture of NA=0.05 to 0.5. For example, the relay lens system may comprise a Numerical Aperture of NA=0.18. For example, the relay lens system may comprises a resolution, in particular an Airy radius, of <20 μm over the full field of view.

The present disclosure, as outlined above, proposes a symmetrical optical system. A superior imaging performance can be achieved due to the symmetry principle described herein. Thus, in contrast to the concept of EP 3 401 721 A1, no tube lens for the imaging system is used, which would violate the concept of symmetry. The present disclosure proposes optics providing 1:1 magnification and modest variations from this, which is inherently linked to the use of the symmetry principle. The symmetry principle may allow simple, low cost optics along with high image quality, i.e., low aberrations. Sufficient resolution in object space (sampling) can be achieved by using a camera with small pixels, diminishing the need for magnification in the field of slide scanning EP 3 401 721 A1, instead, proposes microscopes with a magnification way beyond 1:1. Similarly, US 2011/221881 A1 describes enlarged images, but the present disclosure proposes non-enlarged images which is a consequence of the symmetry principle obeyed in the optical concept. Moreover, US 2015/378143 A1 proposes a camera of a mobile phone in combination with a standard microscope and a microscope eyepiece. The present disclosure does not use an eyepiece since this is not consistent with the symmetry principle, which enables high optical performance at low cost.

The instrument comprises the movable xy-stage configured for setting the slide position. As used herein, the term “xy-stage”, is a broad term and is to be given its ordinary and customary meaning to a person of ordinary skill in the art and is not to be limited to a special or customized meaning. The term specifically may refer, without limitation, to a device configured for relative positioning of slide and camera. The x,y-stage may be connectable with the slide, e.g., by use of a holder, for relative positioning of the slide and camera. The x,y-stage may be a motorized stage. The x,y-stage may be configured for controlling axial movement of the slide transversal to the optical axis, in particular in the x,y-plane.

The term “slide position” as used herein is a broad term and is to be given its ordinary and customary meaning to a person of ordinary skill in the art and is not to be limited to a special or customized meaning. The term specifically may refer, without limitation, to a lateral position of slide relative to the optical axis such as a x,y-position. The slide position may be set by the xy-stage. For example, a first slide position may be at (X1,Y1) and a next slide position may be (X2, Y2). The first slide position and the next slide position may be neighboring lateral x,y-positions. The tem “lateral” may refer to a direction transversal to the optical axis, i.e., in the x,y-plane. The field of view of a 1:1 relay lens system may be definitely smaller than a full slide. For example, the field of view may be Ø 11 mm Optical acquisition of a full slide may be achieved by stitching individual imaging frames, which are recorded sequentially. The term “imaging frame” as used herein is a broad term and is to be given its ordinary and customary meaning to a person of ordinary skill in the art and is not to be limited to a special or customized meaning. The term specifically may refer, without limitation, to at least one image captured at a respective x,y-position. The imaging frame may comprise a plurality of consecutive images captured at a respective x,y-position.

The instrument comprises the at least one processing unit configured for generating a full slide image by stitching the sequentially imaged images of the slide.

The term “processing unit” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. In particular, the processing unit may be configured for processing basic instructions that drive the computer or system. As an example, the processing unit may comprise at least one arithmetic logic unit (ALU), at least one floating-point unit (FPU), such as a math coprocessor or a numeric coprocessor, a plurality of registers, specifically registers configured for supplying operands to the ALU and storing results of operations, and a memory, such as an L1 and L2 cache memory. In particular, the processing unit may be a multicore processor. Specifically, the processing unit may be or may comprise a central processing unit (CPU). Additionally or alternatively, the processing unit may be or may comprise a microprocessor, thus specifically the processing unit's elements may be contained in one single integrated circuitry (IC) chip. Additionally or alternatively, the processing unit may be or may comprise one or more application specific-integrated circuits (ASICs) and/or one or more field-programmable gate arrays (FPGAs) or the like. The processing unit may provide one or more hardware elements for performing one or more of the named operations and/or may provide one or more processors with software running thereon for performing one or more of the named operations. The processing unit may comprise one or more programmable devices such as one or more computers, application-specific integrated circuits (ASICs), Digital Signal Processors (DSPs), or Field Programmable Gate Arrays (FPGAs) which are configured to perform the named operations. Additionally or alternatively, however, the processing unit may also fully or partially be embodied by hardware.

The term “full slide image” as used herein is a broad term and is to be given its ordinary and customary meaning to a person of ordinary skill in the art and is not to be limited to a special or customized meaning. The term specifically may refer, without limitation, to an image covering the whole slide. The full slide image may be a digital image of a virtual slide covering all x,y-positions for which an imaging frame was captured. As used herein, the term “stitching” is a broad term and is to be given its ordinary and customary meaning to a person of ordinary skill in the art and is not to be limited to a special or customized meaning. The term specifically may refer, without limitation, to a process comprising one or more of combining, joining, merging the sequentially imaged images into a composite image. The stitching may comprise at least one cutting step, wherein overlapping regions are cut. As used herein, the term “composite image” generally refers to an image of the entire area of the slide which is composed of sequentially imaged images. The full slide image may be generated such that all x,y-positions are comprised once within the composite image. In particular, none of the x,y-positions is comprised twice. The generating of the full slide image may comprise stitching of fields of view. The stitching may comprise combining the sequentially imaged images with respect to their x,y-position. Methods and techniques for stitching images are known by the skilled person.

For example, assuming an image scale of 1, 4×6=24 images are sufficient for a ⅔′ camera. Pixel sizes in object and image space are the same. In this case a Sony Pregius® CMOS sensor with a standard pixel size of 3.45 μm of can be used which fulfills the 4 μm sampling requirement. For example, 24 imaging frames can be integrated into a virtual slide comprising about 117 Mega Pixel.

The instrument may comprise the milling machine for mechanical dissection, as outlined above. The instrument may comprise the at least one control unit configured for controlling the milling machine based on the full slide image. As further used herein, the term “control unit” generally refers to an arbitrary device configured for performing the named operations, typically by using at least one processing unit and, more typically, by using at least one processor and/or at least one application-specific integrated circuit. Thus, as an example, the at least one control unit may comprise the at least one processing unit. The control unit may in particular be programmatically arranged, for example to control and/or execute imaging the slide. The control unit may in particular be programmatically arranged, for example for controlling and/or executing dissecting the biological specimen. The area of interest to be dissected may be selected using the full slide image. The selection may comprise automatic selection by using at least one image processing tool and/or manual selection by a user. The control unit may be a single-part or multi- part device, which is arranged to control and/or regulate, in whole or in part, an operation of the instrument. The present disclosure may specifically refer to an improvement of an imaging setup, which is part of a milling system. 1× magnification based on the proposed optical concept considering the symmetry principle provides superior optical performance for the registration of the slide regions to be dissected.

The instrument may comprise at least one illuminator configured for illuminating the slide. The term “illuminator” as used herein is a broad term and is to be given its ordinary and customary meaning to a person of ordinary skill in the art and is not to be limited to a special or customized meaning. The term specifically may refer, without limitation, to an arbitrary device configured for emitting light, such as one or more of light in the visible spectral range, the light in the infrared spectral range or light in the ultraviolet spectral range. The illuminator may comprise at least one light source. For example, the illuminator comprises at least one light emitting diode (LED) light source. The illuminator may be configured for emitting light having a single wavelength, e.g., of 486 nm, 588 nm or 656 nm, or may be configured for simultaneously emitting light having different wavelength, e.g., of 486 nm, 588 nm and 656 nm. Other options, however, are also feasible.

As used herein, the term “ray” generally refers to a line that is perpendicular to wavefronts of light which points in a direction of energy flow. As used herein, the term “beam” generally refers to a collection of rays. In the following, the terms “ray” and “beam” will be used as synonyms. As further used herein, the term “light beam” generally refers to an amount of light, specifically an amount of light traveling essentially in the same direction, including the possibility of the light beam having a spreading angle or widening angle.

The instrument may further comprise at least one transfer element configured for guiding a light beam from the illuminator to the slide and for transmitting light from the relay lens system to the camera. The transfer element may be or may comprise at least one beam splitter.

In a further aspect, a method for automatically dissecting a biological specimen on a slide using an instrument for automatically dissecting a biological specimen on a slide according to the present disclosure is proposed. With respect to definitions and embodiments for the method reference is made to the description of the instrument.

The method comprises the following method steps which, specifically, may be performed in the given order. Still, a different order is also possible. It is further possible to perform two or more of the method steps fully or partially simultaneously. Further, one or more or even all of the method steps may be performed once or may be performed repeatedly, such as repeated once or several times. Further, the method may comprise additional method steps which are not listed.

The method comprises the following steps:
a) setting a plurality of slide positions using the movable xy-stage;
b) at each slide position, relaying an impinging light beam from the slide to the camera by using the relay lens system having a fixed focal length and sequentially imaging at least one image of the slide at a plurality of slide position by using the at least one camera of the at least one imaging system;
c) stitching the sequentially imaged images of the slide thereby generating a full slide image by using the processing unit.

The instrument may comprise the milling machine configured for mechanical dissection, wherein the method may comprise controlling the milling machine based on the full slide image by using a control device of the instrument.

The method may be computer-implemented. The term “computer-implemented” as used herein is a broad term and is to be given its ordinary and customary meaning to a person of ordinary skill in the art and is not to be limited to a special or customized meaning. The term specifically may refer, without limitation, to a process which is fully or partially implemented by using a data processing means, such as data processing means comprising at least one processing unit, in particular of the focus electronics and control system. The term “computer”, thus, may generally refer to a device or to a combination or network of devices having at least one data processing means such as at least one processing unit. The computer, additionally, may comprise one or more further components, such as at least one of a data storage device, an electronic interface or a human-machine interface.

Further disclosed and proposed herein is a computer program including computer-executable instructions for performing the method according to the present disclosure in one or more of the embodiments enclosed herein when the program is executed on a computer or computer network, in particular on the processing unit of the instrument. Specifically, the computer program may be stored on a computer-readable data carrier and/or on a computer-readable storage medium.

As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Thus, specifically, one, more than one or even all of method steps a) to c) as indicated above may be performed by using a computer or a computer network, typically by using a computer program.

Further disclosed and proposed herein is a computer program product having program code means, in order to perform the method according to the present disclosure in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute the method according to one or more of the embodiments disclosed herein.

Further disclosed and proposed herein is a computer program product with program code means stored on a machine-readable carrier, in order to perform the method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Finally, disclosed and proposed herein is a modulated data signal which contains instructions readable by a computer system or computer network, for performing the method according to one or more of the embodiments disclosed herein.

Referring to the computer-implemented aspects of the disclosure, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, further disclosed herein are:
a computer or computer network comprising at least one processor, wherein the processor is adapted to perform the method according to one of the embodiments described in this description,
a computer loadable data structure that is adapted to perform the method according to one of the embodiments described in this description while the data structure is being executed on a computer,
a computer program, wherein the computer program is adapted to perform the method according to one of the embodiments described in this description while the program is being executed on a computer,
a computer program comprising program means for performing the method according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the method according to one of the embodiments described in this description after having been loaded into a main and/or working storage of a computer or of a computer network, and
a computer program product having program code means, wherein the program code means can be stored or are stored on a storage medium, for performing the method according to one of the embodiments described in this description, if the program code means are executed on a computer or on a computer network.

Summarizing and without excluding further possible embodiments, the following embodiments may be envisaged:

Embodiment 1. Instrument for automatically dissecting a biological specimen on a slide, wherein the instrument comprises at least one imaging system, wherein the imaging system comprises at least one camera configured for sequentially imaging at least one image of the slide at a plurality of slide positions,
wherein the imaging system comprises a relay lens system having a fixed focal length, wherein the relay lens system is configured for relaying an impinging light beam from the slide to the camera,
wherein the instrument comprises a movable xy-stage configured for setting the slide position, wherein the instrument comprises at least one processing unit configured for generating a full slide image by stitching the sequentially imaged images of the slide.

Embodiment 2. The instrument according to the preceding embodiment, wherein the relay lens system comprises a plurality of lenses, wherein the lenses are arranged symmetrically or quasi-symmetrically with respect at least one plane of symmetry perpendicular to an optical axis.

Embodiment 3. The instrument according to the preceding embodiment, wherein the relay lens system comprises ten lenses, wherein in direction of propagation of the light beam from the slide to the camera the relay lens comprises a bi-concave lens, a meniscus lens, a bi-convex lens, and a doublet lens, followed by a mirrored symmetric arrangement of said lenses.

Embodiment 4. The instrument according to any one of the preceding embodiments, wherein the imaging system has an image scale of about 1:1.

Embodiment 5. The instrument according to any one of the preceding embodiments, wherein the relay lens system comprises a Numerical Aperture of NA=0.05 to 0.5.

Embodiment 6. The instrument according to any one of the preceding embodiments, wherein the relay lens system comprises a resolution of <20 μm over the full field of view.

Embodiment 7. The instrument according to any one of the preceding embodiments, wherein the camera is a pixelated camera, wherein the camera is a charge-coupled device (CCD) and/or a complimentary metal-oxide semiconductor (CMOS) image sensor.

Embodiment 8. The instrument according to any one of the preceding embodiments, wherein the instrument comprises at least one illuminator configured for illuminating the slide, wherein the illuminator comprises at least one light source.

Embodiment 9. The instrument according to any one of the preceding embodiments, wherein the instrument comprises at least one transfer element configured for guiding a light beam from the illuminator to the slide and for transmitting light from the relay lens system to the camera.

Embodiment 10. The instrument according to any one of the preceding embodiments, wherein the instrument comprises a milling machine for mechanical dissection, wherein the instrument comprises at least one control unit configured for controlling the milling machine based on the full slide image.

Embodiment 11. A method for automatically dissecting a biological specimen on a slide using an instrument for automatically dissecting a biological specimen on a slide according to any one of the preceding embodiments, wherein the method comprises the following steps:
a) setting a plurality of slide positions using the movable xy-stage;
b) at each slide position, relaying an impinging light beam from the slide to the camera by using the relay lens system having a fixed focal length and sequentially imaging at least one image of the slide at a plurality of slide position by using the at least one camera of the at least one imaging system;
c) stitching the sequentially imaged images of the slide thereby generating a full slide image by using the processing unit.

Embodiment 12. The method according to the preceding embodiment, wherein the instrument comprises a milling machine configured for mechanical dissection, wherein the method comprises controlling the milling machine based on the full slide image by using a control device of the instrument.

Embodiment 13. The method according to any one of the preceding method embodiments, wherein the method is computer-implemented.

Embodiment 14. A computer program comprising instructions which, when the program is executed by the instrument according to any one of the preceding embodiments referring to an instrument, cause the instrument to perform the method according to any one of the preceding embodiments referring to a method.

Embodiment 15. A computer-readable storage medium comprising instructions which, when the program is executed by the instrument according to any one of the preceding embodiments referring to an instrument, cause the instrument to perform the method according to any one of the preceding embodiments referring to a method.

In order that the embodiments of the present disclosure may be more readily understood, reference is made to the following examples, which are intended to illustrate the disclosure, but not limit the scope thereof.

FIG. 1 shows a schematic illustration of an instrument 110 for automatically dissecting a biological specimen 112 on a slide 114 according to an embodiment of the present disclosure. The instrument 110 comprises at least one imaging system 116. The imaging system 116 comprises at least one camera 118 configured for sequentially imaging at least one image of the slide 114 at a plurality of slide positions. The camera 118 is a pixelated camera. Particularly, the camera 118 is a charge-coupled device (CCD) image sensor. Alternatively or in addition, the camera 118 is a complimentary metal-oxide semiconductor (CMOS) image sensor. The imaging system 116 has an image scale of about 1:1.

The imaging system 116 comprises a relay lens system 120 having a fixed focal length. The relay lens system 120 is configured for relaying an impinging light beam 122 from the slide 114 to the camera 118.

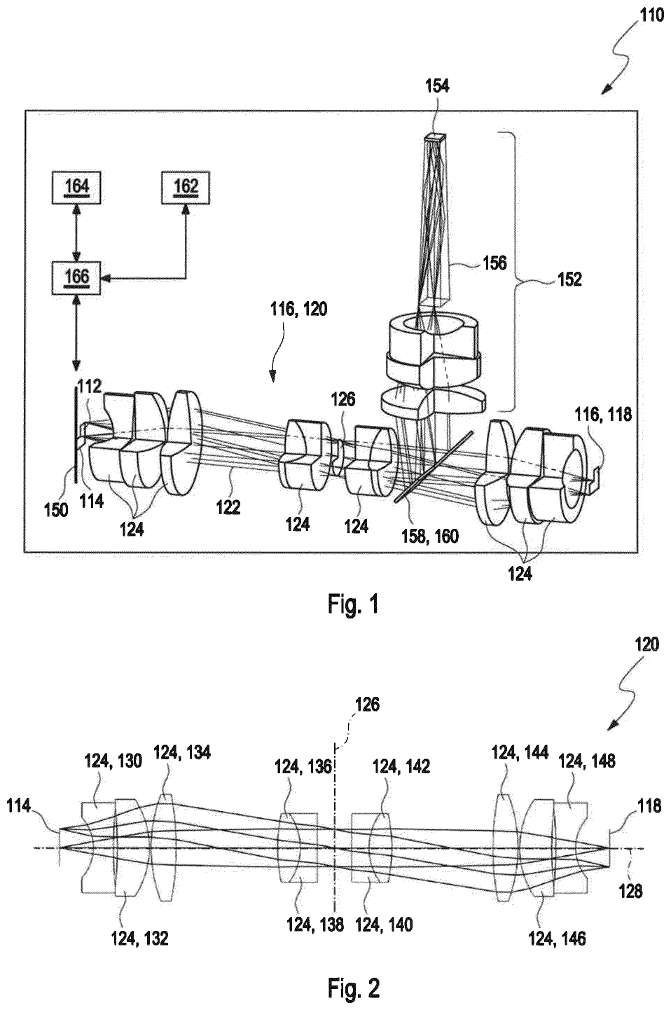

FIG. 2 shows a schematic illustration of the relay lens system 120. As shown in FIG. 2, the relay lens system 120 comprises a plurality of lenses 124. The lenses 124 are arranged symmetrically or quasi-symmetrically with respect at least one plane of symmetry 126 perpendicular to an optical axis 128. The relay lens system 120 may constitute the optical axis 128. The plane perpendicular to the optical axis 128 may be the x,y-plane. The relay lens system 120 may constitute a coordinate system, wherein “z” is a coordinate along the optical axis 128, also denoted as z-axis or z-direction. A coordinate along the z-axis may be considered a longitudinal coordinate z. The directions transversal to the z-axis may be considered as x- and y-directions. The x- and y-directions span the x,y-plane. Particularly, the relay lens system 120 comprises ten lenses 124. In a direction of propagation of the light beam 122 from the slide 114 to the camera 118, the relay lens comprises a bi-concave lens, a meniscus lens, a bi-convex lens followed by a cemented doublet lens, followed by a mirrored symmetric arrangement of said lenses 124. With other words, the relay lens system 120 comprises a first bi-concave lens 130, a first meniscus lens 132, a first bi-convex lens 134, a first doublet comprising the elements 136 and 138, and the mirrored counterparts 140, 142, 144, 146 and 148 if seen in the direction of propagation of the light beam 122 from the slide 114 to the camera 118.

The first bi-concave lens 130, first meniscus lens 132, the first bi-convex lens 134, the first doublet comprising the elements 136 and 138 are arranged on the one side with respect to the plane of symmetry 126, wherein the second doublet comprising the elements 140 and 142, the second bi-convex lens 144, the second meniscus 146, the second bi-concave lens 148 are arranged on the other side with respect to the plane of symmetry 126. The plane of symmetry 126 may be regarded as mirror axis in a 2D section. The aperture stop may be located in the plane of symmetry 126.

As mentioned above, the relay lens system 120 has a fixed focal length. With other words, the focal length of the relay lens system 120 is fixed, in particular non-adjustable. The focal length of the relay lens system 120 may be defined by the selection and fixed position of the respective lenses 124 comprised by the relay lens system 120. The relay lens system 120 comprises a Numerical Aperture of NA=0.05 to 0.5 such as 0.18. Further, the relay lens system 120 comprises a resolution of <20 μm over the full field of view such as 4 μm. Thus, the relay lens system 120 is configured for extending a length of the optical system of the instrument 110. The relay lens system 120 may be configured for inverting the image. Exemplarily, two field points are shown (axis point and field edge).

As is further shown in FIG. 1, the instrument 110 comprises a movable xy-stage 150 configured for setting the slide position. The xy-stage 150 is a motorized xy-stage 150. The xy-stage 150 is coupled to the slide 114 and is configured to move the slide 114 in a xy-plane. Particularly, the xy-stage is configured for controlling movement of the slide 114 transversal to the optical axis 128.

The instrument 110 further comprises at least one illuminator 152 configured for illuminating the slide 114. The illuminator 152 comprises at least one light source 154. The illuminator 152 may comprise at least one light source 154. Merely as an example, the illuminator 152 comprises at least one light emitting diode (LED) light source. The illuminator 152 may be configured for emitting light having a single wavelength, e.g., of 486 nm, 588 nm or 656 nm, or may be configured for simultaneously emitting light having different wavelength, e.g., of 486 nm, 588 nm and 656 nm. Such a LED light source 154 allows allow high peak illumination of the specimen 112.

The illuminator 152 further comprises a mixing rod 156. An entrance facet of the mixing rod 156 may be in close contact with the light source 154. Therefore, the spatial light distribution at the entrance facet is non-uniform to the same degree as the light source itself. The mixing rod 156 may be configured for guiding the light to the exit facet via multiple bounces at the side walls based on total internal reflexion. The light distribution at the exit facet is spatially uniform then and forms a secondary light source.

The instrument 110 further comprises at least one transfer element 158 configured for guiding a light beam 122 from the illuminator 152 to the slide 114 and for transmitting light from the relay lens system 120 to the camera 118. The transfer element 158 may be or may comprise at least one beam splitter 160.

The instrument 110 further comprises at least one processing unit 162 configured for generating a full slide image by stitching the sequentially imaged images of the slide 114. It has to be noted that the field of view of a 1:1 relay lens system 120 may be definitely smaller than a full slide 114. For example, the field of view may be Ø 11 mm Optical acquisition of a full slide 114 may be achieved by stitching individual imaging frames, which are recorded sequentially.

The instrument 110 further comprises a milling machine 164 for mechanical dissection. Dissecting relates to a process of extracting at least one specific area of interest of the biological specimen 112 mounted on the slide 114. Extracting may comprise one or more of cutting, disrupting, milling and the like. Several techniques for dissecting are known by the skilled person. For example, the dissecting may comprise ablating such as by scraping the biological specimen 112, e.g., by using at least one cutting device such as a scalpel, also denoted as macrodissection, and/or by using laser-based instruments, also denoted as Laser Capture Microdissection (LCM). For example, the dissecting may comprise mesodissection. The mesodissection may be performed as described in US 2014/0329269 A1, WO 2016/120433 A1, or U.S. Pat. No. 10,876,933 B2, which are incorporated herein in entirety by reference. The instrument 110 may comprise at least one milling machine 164. The milling machine 164 may comprise at least one extractor, such as a cutting tip, configured for extracting configured for extracting the at least one specific area of interest of the biological specimen 112 mounted of the slide 114. The milling machine 164 may comprise further elements such as at least one liquid dispensing port configured for dispensing liquid to the slide 114 and/or at least one liquid aspiration port configured for aspirating liquid to the slide 114 at a sample facing side of the extraction device. The instrument 110 further comprises at least one control unit 166 configured for controlling the milling machine 164 based on the full slide image. Movement of the xy-stage 150 is also controlled by the control unit 166. The processing unit 162 is functionally coupled to the control unit 166. The processing unit 162 is configured for identifying the specific area of interest of the biological specimen 112 to be extracted.

The instrument 110 may be used to perform a method for automatically dissecting a biological specimen 112 on a slide 114. The method may be computer implemented. For this purpose, the instrument 110 may comprise a computer and may be linked to a computer, respectively.

First, a plurality of slide positions using the movable xy-stage 150 is set. For example, a first slide 114 position may be at (X1,Y1) and a next slide 114 position may be (X2, Y2). The first slide 114 position and the next slide 114 position may be neighboring lateral x,y-positions. Then, at each slide 114 position, an impinging light beam 122 is relayed from the slide 114 to the camera 118 by using the relay lens system 120 having the fixed focal length and sequentially imaging at least one image of the slide 114 at a plurality of slide 114 position by using the at least one camera 118 of the at least one imaging system 116. Finally, the sequentially imaged images of the slide 114 are stitched thereby generating a full slide 114 image by using the processing unit 162.

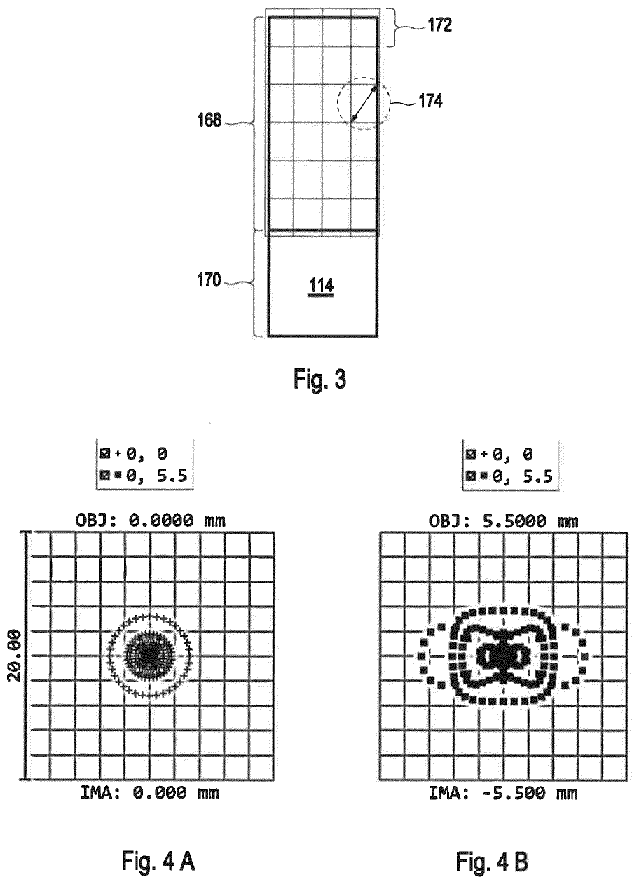

FIG. 3 shows a top view of an exemplary slide 114. FIG. 3 explains the stitching of the sequentially imaged images in further detail. As shown in FIG. 3, the slide 114 includes a sample section 168 for supporting the specimen 112 and a labelling section 170. Merely as an example, the sample section 168 includes an area of 25×50 mm² and the labelling section 170 includes an area of 25×25 mm² The field of view 172 of the camera 118 may be 6.6×8.8 mm². The field of view 174 of a 1:1 relay lens system 120 may be definitely smaller than a full slide 114. For example, the field of view 174 of the relay lens system 120 may be Ø 11 mm As shown in FIG. 3, just as a zoom concept, stitching requires the acquisition of multiple image frames for covering a full slide 114. For example, assuming an image scale of 1, 4×6=24 images are sufficient for a ⅔′ camera 118. Pixel sizes in object and image space are the same. In this case a Sony Pregius® CMOS sensor with a standard pixel size of 3.45 μm of can be used which fulfills the 4 μm sampling requirement. For example, 24 imaging frames can be integrated into a virtual slide 114 comprising about 117 Mega Pixel.

In order to explain the optical performance of the instrument 110 and the relay lens system 120, respectively, in further detail, some illustrative examples are given hereinafter.

FIGS. 4A to 4B show spot diagrams with different positions at the object (OBJ) surface for the axis point with a field height of 0 mm and for the field edge with a field height of 5.5 mm at a surface image IMA as indicated by the legend in the FIGS. 4A to 4B. As can be taken from FIGS. 4A to 4B, the root mean square spot radius matches the Airy radius of 2 μm over the full field of view. This indicates diffraction limited performance. Further, there is no significant drop of optical performance at the edge of the image.

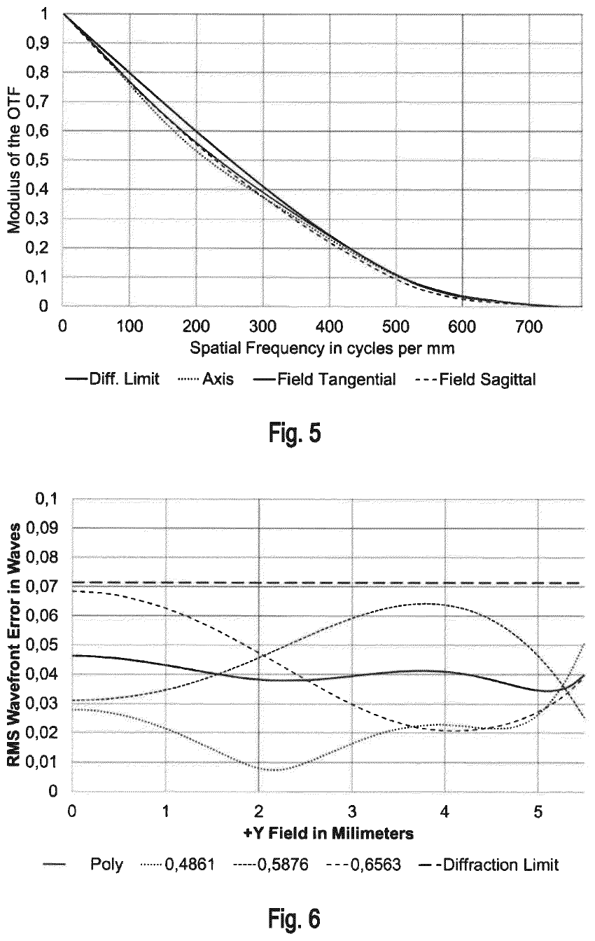

FIG. 5 shows a contrast transfer function indicating a polychromatic diffraction Modulation Transfer Function (MTF). The x-axis indicates a spatial frequency in cycles per mm. The y-axis indicates the modulus of the optical transfer function (OTF). The graphs refer to different field positions as indicated by the legend in the FIG. 5. As can be taken from FIG. 5, the contrast transfer function is close to the theoretical limit resulting from diffraction.

FIG. 6 shows the root mean square error of the wavefront. The x-axis indicates a +Y field in mm. The y-axis indicates the root mean square wavefront error in waves. The graphs refer to different wavelengths of polychromatic light, 486 nm, 587 nm and 656 nm and diffraction limit as indicated by the legend in the FIG. 6. The root mean square wavefront error is the most accepted criterion for the optical performance of an imaging lens. The diffraction limit is defined as 1/14 waves. As can be taken from FIG. 6, the proposed design fulfils the diffraction limit for all field points and all wavelengths.

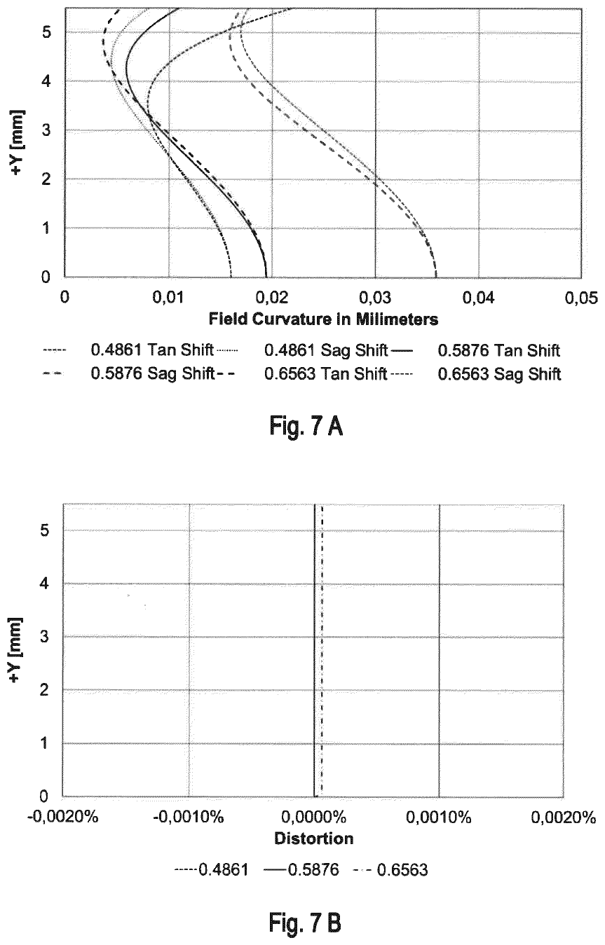

FIG. 7A shows a field curvature and FIG. 7B a field distortion. The field curvature plot shows the distance from the image surface to the paraxial image surface (x-axis) as a function of field coordinate (y-axis). The tangential data are the distances measured along the Z-axis from the image surface to the paraxial image surface measured in the tangential (YZ) plane. The sagittal data are the distances measured in the plane orthogonal to the tangential plane. The graphs refer to different wavelengths of 486 nm, 587 nm and 656 nm as indicated by the legend in the FIG. 7A. In FIG. 7B, the x-axis indicates the distortion in percent and the y-axis indicates the +Y position. The graphs refer to different wavelengths of 486 nm, 587 nm and 656 nm as indicated by the legend in the FIG. 7B. As can be taken from FIGS. 7A and 7B, the image is flat to about 16 μm. The image distortion is exactly zero. The absence of any distortion massively supports the proposed stitching concept. No rectification procedure needs to be implemented for achieving a seamless stitching result. The individual tiles (frames) are matching inherently.

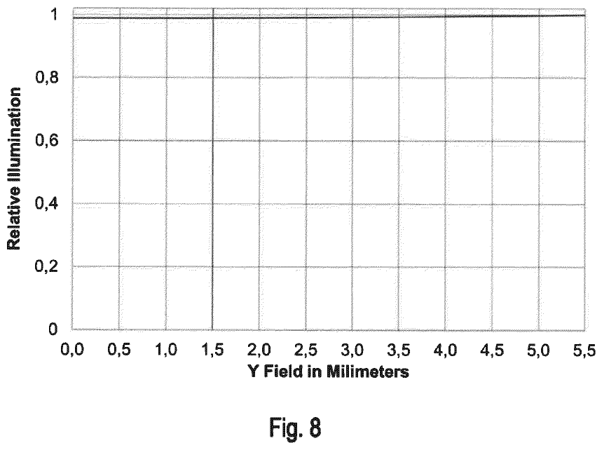

FIG. 8 shows a vignetting and spatial uniformity. The x-axis indicates a +Y field in mm. The y-axis indicates a relative illumination. The graph refers to a relative illumination at a wavelength of 587 nm. As can be taken from FIG. 8, there is no vignetting. Similar to the distortion topic, the excellent spatial uniformity supports the stitching approach. The raw images do not need any field flattening operations for achieving a seamless tiling.

### LIST OF REFERENCE NUMBERS

110 instrument
112 specimen
114 slide
116 imaging system
118 camera
120 relay lens system
122 light beam
124 lens
126 plane of symmetry
128 optical axis
130 bi-concave lens
132 meniscus lens
134 bi-convex lens
136 element of doublet lens
138 element of doublet lens
140 mirrored counterpart
142 mirrored counterpart
144 mirrored counterpart
146 mirrored counterpart
148 mirrored counterpart
150 xy-stage
152 illuminator
154 light source
156 mixing rod
158 transfer element
160 beam splitter
162 processing unit
164 milling machine
166 control unit
168 sample section
170 labelling section
172 field of view of camera
174 field of view of relay lens system

What is claimed is:

1. An instrument for automatically dissecting a biological specimen on a slide, wherein the instrument comprises at least one imaging system, wherein the imaging system comprises at least one camera configured for sequentially imaging at least one image of the slide at a plurality of slide positions,
wherein the imaging system comprises a relay lens system having a fixed focal length, wherein the relay lens system is configured for relaying an impinging light beam from the slide to the camera,
wherein the instrument comprises a movable xy-stage configured for setting the slide position,
wherein the instrument comprises at least one processing unit configured for generating a full slide image by stitching the sequentially imaged images of the slide, and
wherein the relay lens system comprises a plurality of lenses, wherein the lenses are arranged symmetrically or quasi-symmetrically with respect to at least one plane of symmetry perpendicular to an optical axis.

2. The instrument according to claim 1, wherein the relay lens system comprises ten lenses, wherein in direction of propagation of the light beam from the slide to the camera the relay lens comprises a bi-concave lens, a meniscus lens, a bi-convex lens, and a doublet lens, followed by a mirrored symmetric arrangement of said lenses.

3. The instrument according to claim 1, wherein the imaging system has an image scale of about 1:1.

4. The instrument according to claim 1, wherein the relay lens system comprises a Numerical Aperture of NA=0.05 to 0.5.

5. The instrument according to claim 1, wherein the relay lens system comprises a resolution of <20 μm over the full field of view.

6. The instrument according to claim 1, wherein the camera is a pixelated camera, wherein the camera is a charge-coupled device (CCD) and/or a complimentary metal-oxide semiconductor (CMOS) image sensor.

7. The instrument according to claim 1, wherein the instrument comprises at least one illuminator configured for illuminating the slide, wherein the illuminator comprises at least one light source.

8. The instrument according to claim 1, wherein the instrument comprises at least one transfer element configured for guiding a light beam from the illuminator to the slide and for transmitting light from the relay lens system to the camera.

9. The instrument according to claim 1, wherein the instrument comprises a milling machine for mechanical dissection, wherein the instrument comprises at least one control unit configured for controlling the milling machine based on the full slide image.

10. A method for automatically dissecting a biological specimen on a slide using an instrument for automatically dissecting a biological specimen on a slide according to claim 1, wherein the method comprises the following steps:
a) setting a plurality of slide positions using the movable xy-stage;
b) at each slide position, relaying an impinging light beam from the slide to the camera by using the relay lens system having a fixed focal length and sequentially imaging at least one image of the slide at a plurality of slide positions by using the at least one camera of the at least one imaging system; and
c) stitching the sequentially imaged images of the slide thereby generating a full slide image by using the processing unit.

11. The method according to claim 10, wherein the instrument comprises a milling machine configured for mechanical dissection, wherein the method comprises controlling the milling machine based on the full slide image by using a control device of the instrument.

12. The method according to claim 10, wherein the method is computer-implemented.
